(19) United States
(12) Patent Application Publication
(10) Pub. No.: US 2007/0035751 A1
(43) Pub. Date: Feb. 15, 2007

(54) Gamut shape dependent color management system

(75) Inventors: Anthony M. Presley, Bellevue, WA (US); Jeff Bloomfield, Redmond, WA (US); Michael D. Stokes, Eagle, ID (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/203,739

(22) Filed: Aug. 15, 2005

(51) Int. Cl. H04N 1/60

(52) U.S. Cl. 358/1.9

(57) ABSTRACT

A color management system is provided for mapping color data from a source device gamut to a destination device gamut using information regarding a gamut shape for the source device and the destination device. The color management system includes a gamut shape determining component that is capable of determining the information regarding the gamut shape for the source device and the destination device. The color management system also includes a gamut mapping model association component that is capable of determining a gamut mapping model based on the information regarding the gamut shape for the source device and the destination device. The color management system further includes a gamut mapping model invoking component that is capable of invoking the gamut mapping model and applying gamut mapping algorithms of the gamut mapping model to map the color data from the source device gamut to the destination device gamut.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

Color management systems attempt to compensate for the different color capabilities of devices, viewing conditions, and subjective preferences. Different devices interpret and reproduce color differently and are often referred to as having disparate color capabilities. In particular, each device has a limited range of colors (e.g., as represented by lightness, chroma, and hue) that the device may detect and/or produce. This limited range is often referred to as the device color gamut. As a result of different device color capabilities, color data may appear visually different on two separate devices. For example, a document displayed on a monitor may look different when displayed on a different monitor or printed on a printer. Further, it should be noted that as opposed to being associated with an actual device, color data may be associated with a virtual device, such as stored on disk in a file format representative of a virtual device (e.g., sRGB) that has associated color characteristics, for example. Accordingly, as used herein, the term “device” may refer to either an actual device or a virtual device.

In order to compensate for the different color capabilities of devices, color management systems may apply color transformations to color data in order to map the colors from a source device to a destination device, typically using profiles for each device that describe parameters, such as native device capabilities, viewing conditions, and subjective preferences. The profiles associated with each device may either implicitly or explicitly set forth each of these parameters. As part of the transformations, gamut mapping is often employed to resolve the discrepancies between the gamuts of the source and destination devices.

One current approach to color management employs a standard intermediate color space for transforming color data from a source device to a destination device. Under this approach, color data from a source device is first converted from the source device to the standard intermediate color space. As part of this transformation, the color data is mapped from the source device gamut to the intermediate color space gamut. The color data is then converted from the standard intermediate color space to the destination device, including mapping the color data from the intermediate color space gamut to the destination device gamut. Currently, the most commonly employed intermediate color space is the sRGB color space.

Another color management system solution is profile management. The most common implementation of this solution is the International Color Consortium (ICC) standard. Under this approach, each device has a profile that characterizes the relationship between the device capabilities and the human visual system as specified in an ICC workflow as an ICC profile connection space (PCS). Color transformations between devices may be created using the device profiles. The color transformation may then be applied to convert color data between the devices.

Current color management system solutions, such as those previously described, present a number of drawbacks. For example, the intermediate color space may be too constraining if it employs a small gamut. As a result, color fidelity is sacrificed when devices have a color gamut greater than that of the intermediate color space. In addition, the device gamut is mapped to the intermediate color space gamut by the device vendor in a manner that application developers and end users have no control over. The profile management approach, such as the ICC standard, allows device vendors to embed the gamut mapping between the device space to the PCS in an opaque way. This similarly limits the control software developers and end users have over gamut mapping performed between devices. Further, current color management systems typically confound and hard code gamut shapes into color profiles or internal generic structures. This eliminates the possibility for sophisticated processes based upon the gamut shapes of devices to optimize the gamut mapping from one device to another.

### BRIEF SUMMARY

This Brief Summary is provided to introduce a selection of concepts in a simplified form that are further described below in the Detailed Description. This Brief Summary is not intended to identify key features or essential features of the claimed subject matter, nor is it intended to be used as an aid in determining the scope of the claimed subject matter.

Embodiments of the present invention provide a color management system that uses information regarding the shapes of device gamuts to provide optimum translation of color data between different device gamuts. The color management system may access information regarding the shape of device gamuts and associate those shapes (and/or boundary representations of those gamut shapes) with gamut mapping models that translate between different gamuts. The device gamut shapes used may be actual, theoretical, derived, or idealized gamut shapes. In addition, in some embodiments, the gamut shape may be controlled to force or correct some behavior of the gamut mapping model. Besides having gamut mapping models hard coded into the system, in some embodiments, the color management system may provide the ability for third parties to plug-in gamut mapping models. In some embodiments of the invention, the color management system may also expose gamut mapping models via a user interface to allow users to interactively control parameters of the gamut mapping performed by the color management system.

### BRIEF DESCRIPTION OF THE SEVERAL VIEWS OF THE DRAWING

The present invention is described in detail below with reference to the attached drawing figures, wherein:

FIG. 1 is a block diagram of an exemplary computing environment suitable for use in implementing the present invention;

FIG. 2 is a block diagram of an exemplary color management system in accordance with an embodiment of the present invention;

FIG. 3 is a block diagram illustrating gamut mapping components of a color management system in accordance with an embodiment of the present invention;

FIG. 4 is a flow diagram showing an exemplary method for mapping color data from a source device gamut to a destination device gamut in accordance with an embodiment of the present invention; and

FIG. 5 is a flow diagram showing another exemplary method for mapping color data from a source device gamut to a destination device gamut in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems and methods for mapping color data between device gamuts based on information regarding the gamut shape for the devices. Although the invention is generally described herein with respect to mapping color data from a source device gamut to a destination device gamut, it should be noted that the invention may be employed between more than two devices and/or in a chained process. For instance, in the case of proofing, a destination device may serve as the source for mapping to another device. Proofing is the process of visually inspecting output color data on a device that is not the intended output device. For example, users often preview color data on a monitor before printing (commonly known as soft proofing). In such a case, the color data may be mapped in a chained process from a source gamut to the printer gamut and then to the monitor gamut.

In one aspect, an embodiment of the present invention is directed to a color management system for mapping color data from a source device gamut to a destination device gamut using information regarding a gamut shape for the source device and information regarding a gamut shape for the destination device. The color management system includes a gamut shape determining component, a gamut mapping model association component, and a gamut mapping model invoking component. The gamut shape determining component is capable of determining the information regarding the gamut shape for the source device and the information regarding the gamut shape for the destination device. The gamut mapping model association component is capable of determining at least one gamut mapping model based on the information regarding the gamut shape for the source device and the information regarding the gamut shape for the destination device. The gamut mapping model invoking component is capable of invoking the at least one gamut mapping model and applying at least one gamut mapping algorithm of the at least one gamut mapping model to map the color data from the source device gamut to the destination device gamut.

In another aspect of the invention, an embodiment relates to a method for mapping color data from a source device gamut to a destination device gamut based on information regarding a gamut shape for the source device and information regarding a gamut shape for the destination device. The method includes accessing information regarding the gamut shape of the source device. The method also includes accessing information regarding the gamut shape of the destination device. The method further includes determining a gamut mapping model based on the information regarding the gamut shape of the source device and the information regarding the gamut shape of the destination device. The method still further includes invoking the gamut mapping model and applying at least one gamut mapping algorithm of the gamut mapping model to the color data to map the color data from the source device gamut to the destination device gamut.

A further aspect of the present invention is directed to a color management system for associating at least one gamut mapping model with information regarding a gamut shape for at least one device. The color management system includes a gamut shape determining component, a gamut mapping model database, and a gamut mapping association component. The gamut shape determining component is capable of accessing information regarding the gamut shape of the at least one device. The gamut mapping model database is capable of storing a plurality of gamut mapping models. The gamut mapping model association component is capable of associating at least one of the plurality of gamut mapping models with the information regarding the gamut shape of the at least one device.

Having briefly described an overview of the present invention, an exemplary operating environment for the present invention is described below.

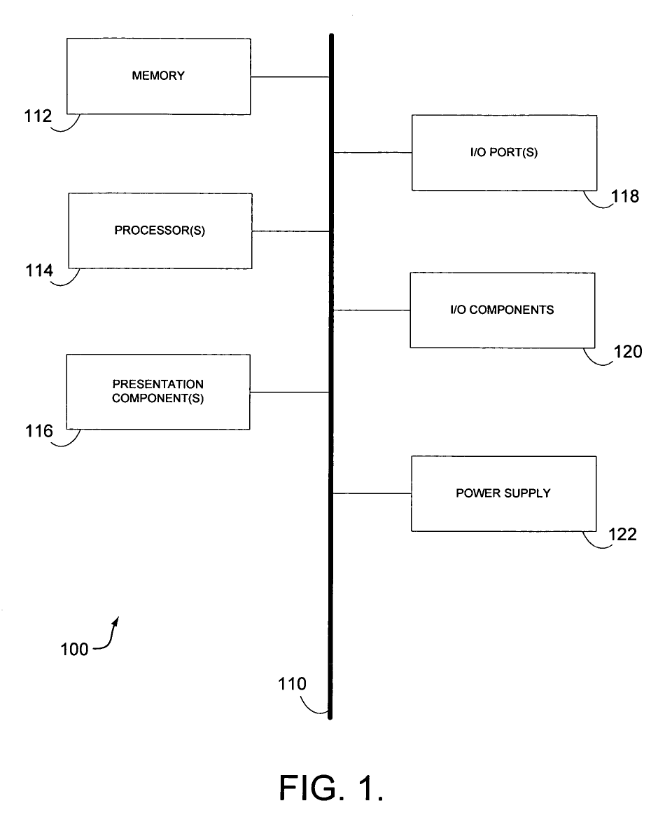

Referring initially to FIG. 1 in particular, an exemplary operating environment for implementing the present invention is shown and designated generally as computing device 100. computing device 100 is but one example of a suitable computing environment and is not intended to suggest any limitation as to the scope of use or functionality of the invention. Neither should the computing-environment 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. By way of example, and not limitation, computer-readable media may comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

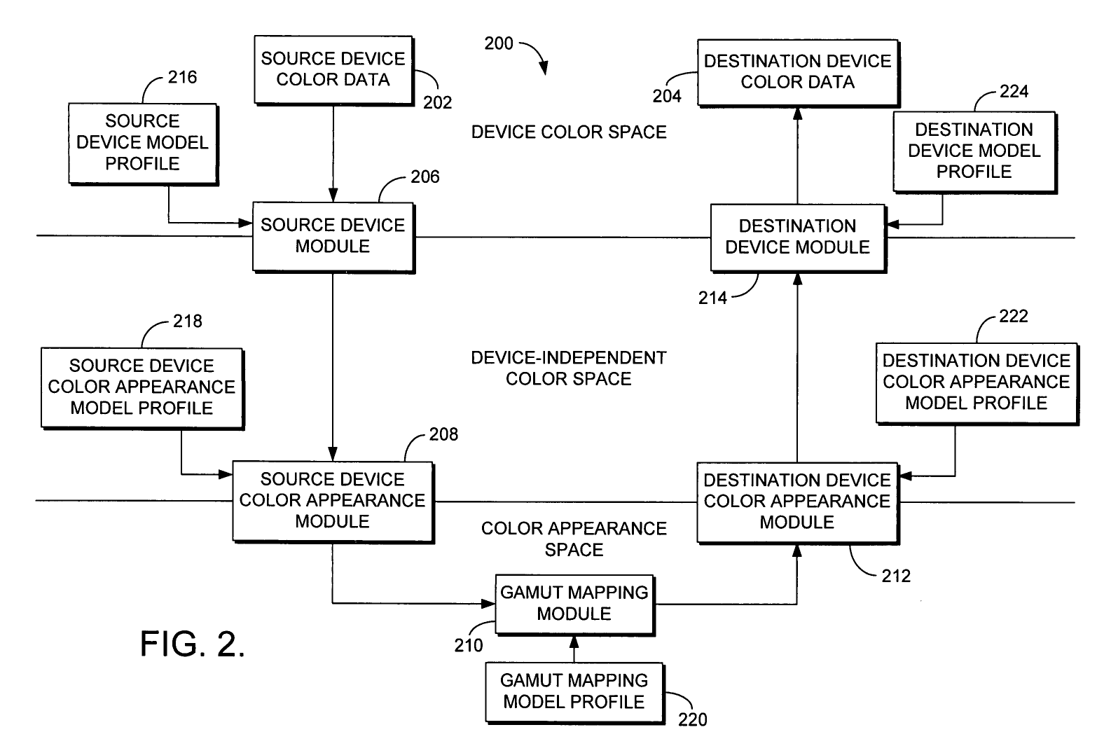

Embodiments of the present invention may be implemented in a modularized color management system in which portions of the color transformation process may be separately controlled and performed. Turning to FIG. 2, a block diagram is illustrated which shows an exemplary modularized color management system 200 in which embodiments of the present invention may be employed. The modularized color management system 200 may convert color data 202 from a source device to color data 204 for a destination device. For example, the modularized color management system 200 may convert color data from a monitor to a printer, such that colors on printed documents match colors displayed on the monitor. Among other components, the modularized color management system 200 may include a source device module 206, a source device color appearance module 208, a gamut mapping module 210, a destination device color appearance module 212, and a destination device module 214.

The source device module 206 may receive color data 202 from a source device and translate the data from the source device's native signal into a set of perceived measurements that relate to how the human visual system perceives colors. Accordingly, the source device module 206 converts the color data from a device color space for the source device to a device-independent color space. For example, the device-independent color space may be the standard CIEXYZ color space. To perform the conversion, the source device module 206 may access a source device model profile 216 containing the algorithms necessary for the conversion.

Using the device-independent set of human visual measurements from the source device module 206, the source device color appearance module 208 compensates for the source device viewing conditions. Accordingly, the source device color appearance module 208 uses a source device color appearance model profile 218 to convert the color data from the device-independent color space to a color appearance space. For example, the color appearance space may be the standard CIEJch color space.

The gamut mapping module 210 performs gamut mapping by converting the color data in the appearance color space from the source device gamut to the destination device gamut. A gamut mapping model profile 220 is provided to the gamut mapping module 210 to perform this step. The gamut mapping model profile 220 contains a gamut mapping model with gamut mapping algorithms for mapping color data between device gamuts. The conversion could be a straight mapping from the source device gamut to the destination device gamut. Alternatively, the conversion could involve a variety of different subjective translations.

After the gamut mapping has been performed, the color data is converted from the color appearance space to the device-independent color space by the destination device color appearance module 212. A destination device color appearance model profile 222 is employed by the destination device color appearance module 212 for this conversion. Using a destination device model profile 224, the destination device module 214 then converts the color data from the device-independent color space to a device color space for the destination device.

By modularizing the color transformation process, the color management system, among other things, provides significant flexibility and control. Each of the five steps or modules described above with reference to FIG. 2 can be exposed via an XML (extensible markup language) profile, for example, that may be easily edited and controlled. In particular, the gamut mapping portion of the color management system may be implemented independent of other steps. As a result, embodiments of the present invention may, among other things, provide a color management system in which users have enhanced control over the gamut mapping conversions performed between devices, including the ability to dynamically control the parameters of gamut mapping models applied to color data.

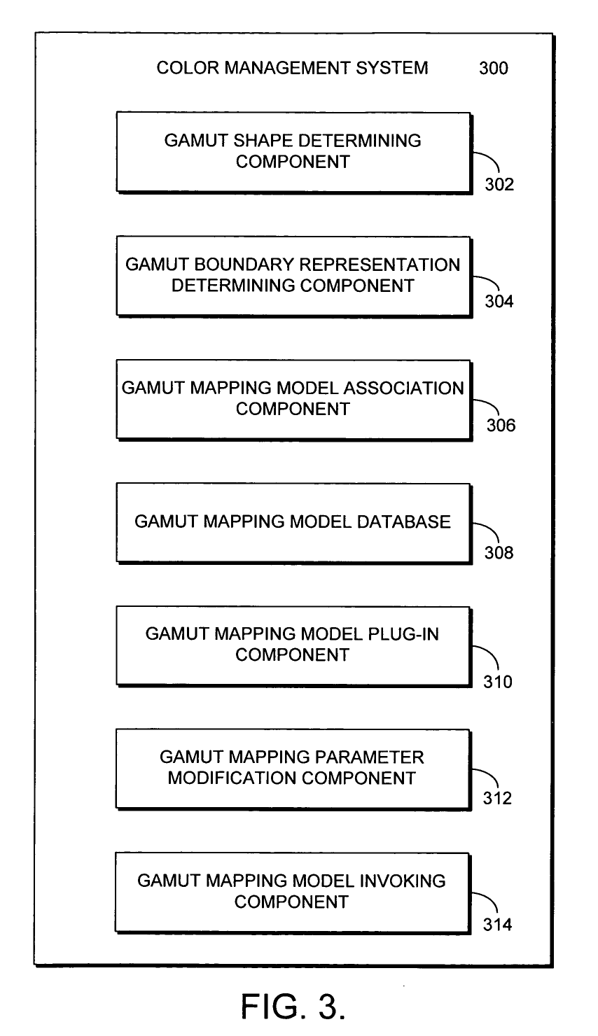

Referring to FIG. 3, a block diagram is illustrated that shows gamut mapping components of an exemplary color management system 300 in accordance with an embodiment of the present invention. Among other components not shown, the color management system 300 may include a gamut shape determining component 302, a gamut boundary representation determining component 304, a gamut mapping model association component 306, a gamut mapping model database 308, a gamut mapping model plug-in component 310, a gamut mapping parameter modification component 312, and a gamut mapping model invoking component 314.

The gamut shape determining component 302 may access information about the gamut shape for different devices. The gamut shape information for each of the devices may be accessed in a number of ways. Generally, the gamut shape determining component 302 operates as an interface to obtain the gamut shape information. By way of example only and not limitation, the gamut shape determining component 302 may analyze sampling data in the color appearance space. The gamut shape determining component 302 may also access gamut shape information from device profiles containing such information. Further, the gamut shape determining component 302 may access gamut shape information through user-provided information. The gamut shape information may also be derived from interface methods of device models.

In some cases, it may be advantageous to provide gamut boundary representations based on the information regarding the gamut shapes accessed by the gamut shape determining component 302. For example, it may be easier to work with a simple gamut boundary representation as opposed to a complex gamut shape. As used herein, the term “gamut boundary representations” refers to the type and properties of gamut representation (e.g., convex, continuous, etc.), as opposed to the actual gamut boundary. Accordingly, the color management system 300 may also include a gamut boundary representation determining component 304 that determines the optimal way to represent the gamut shape for each device. The gamut boundary representation determining component 304 may handle any three-dimensional gamut shape and determine whether a particular gamut boundary representation is appropriate for that gamut shape. By way of example only and not limitation, the gamut boundary representation determining component 304 may be able to query different types of hulls and determine which hull is appropriate for the gamut shape for a device. For example, the gamut boundary representation determining component 304 may determine the type of wrapping done in a single hull (e.g., convex, etc.) or may determine how many hulls to use if the gamut is discontinuous. Further, the gamut boundary representation determining component 304 may incorporate a variety of constraints to create a well-behaved gamut boundary representation based on whatever color capabilities a device may have.

The color management system 300 may also include a gamut mapping model association component 306 that may make associations between gamut mapping models and gamut information for devices. In various embodiments of the present invention, the gamut mapping model association component 306 may use either or both gamut shape information, such as that accessed by the gamut shape determining component 302, for example, and gamut boundary representations, such as that determined by the gamut boundary representation determining component 304, for example. The gamut mapping model association component 306 associates the gamut information (i.e. either or both the gamut shape information and the gamut boundary representations) with gamut mapping algorithms that may be used to translate between different device gamuts. The gamut mapping model association component 306 may, for example, make the associations based on which gamut boundary representations or gamut shape information the gamut mapping models support and how well the gamut mapping models support them. A variety of information may be accessed to make the gamut mapping associations, including, for example, profile management information, gamut mapping model profiles, gamut mapping interface method, and a color policy database. The gamut mapping model association component 306 may maintain association information in a database, for example, which may be accessed at runtime. Additionally or alternatively, the gamut mapping model association component 306 may query gamut mapping models at runtime to determine if and/or how well the various gamut mapping models handle the gamut information.

The color management system 300 may further include a gamut mapping model database 308 that the gamut mapping model association component 306 may access. Some gamut mapping models may be hard coded in the gamut mapping model database 308. In addition, the color management system 300 may include a gamut mapping model plug-in component 310, which allows end-users and software developers, for example, to plug-in gamut mapping models to the color management system 300. In some embodiments, the plug-in gamut mapping models may then be stored in the gamut mapping model database 308 with any gamut mapping models hard coded in the database 308.

The color management system 300 may also include a gamut mapping parameter modification component 312 that may allow users to interactively control the gamut mapping performed by the color management system 300. The gamut mapping parameter modification component 312 may expose parameters of gamut mapping models, allowing users to modify those parameters. As a result, users may subjectively control the look and feel of images during the color transformation process. After a user has modified the parameters of a gamut mapping model, the user may save the model with the modified parameters in the gamut mapping model database 308, for example.

A wide variety of parameters may be exposed for user-modification by the gamut mapping parameter modification component 312. By way of example only and not limitation, if gamut mapping is performed in the CIEJch color appearance space, the gamut mapping parameter modification component 312 may expose parameters to allow users to control lightness, chroma, and hue. For example, the gamut mapping parameter modification component 312 may present a user interface with slider bars that allows users to adjust each of these parameters. Accordingly, a user may modify each of these parameters within a gamut mapping model, such that when the model is applied to color data, these parameters are adjusted based on the user-defined settings. One skilled in the art will recognize that lightness, chroma, and hue parameters are exemplary only and a wide variety of parameters may be exposed and user-modified within the scope of the present invention.

The color management system 300 may further include a gamut mapping model invoking component 314 that may invoke the gamut mapping model algorithms. The gamut mapping model invoking component 314 must be capable of invoking those algorithms based on the gamut information (i.e. the information regarding the gamut shape or the gamut boundary representations) for the source device and destination device, as well as any parameters that were modified via the gamut mapping parameter modification component 312.

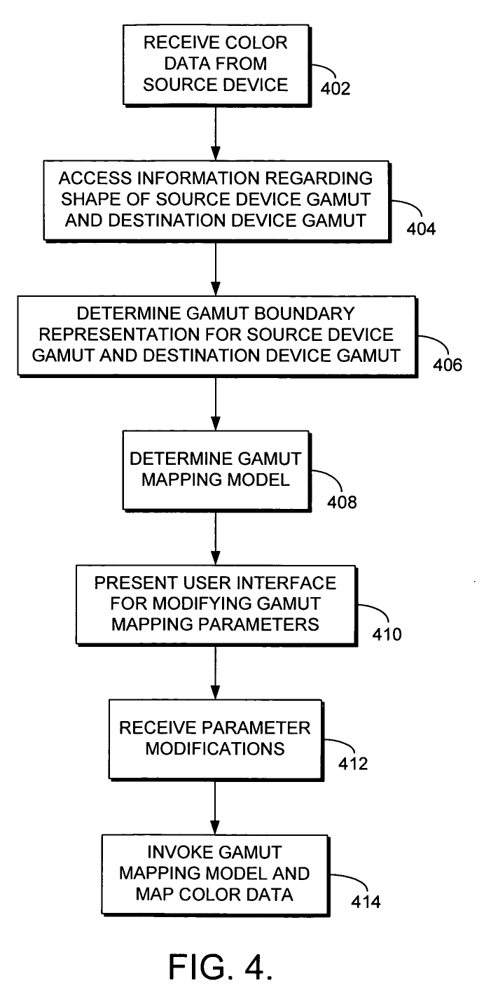

Turning now to FIG. 4, a flow diagram is provided illustrating an exemplary method 400 in which a color management system (e.g., the color management system 300 of FIG. 3) maps color data from a source device gamut to a destination device gamut in accordance with an embodiment of the present invention. Initially, the color management system receives color data from the source device at block 402. The color management system then accesses information regarding the shape of the source device gamut and the shape of the destination device gamut, as shown at block 404. For example, the color management system may access the information by analyzing sampling data in the color appearance space, from information contained in a device profile for each of the source device and destination device, or from user-provided information. In some embodiments of the invention, the color management system determines a gamut boundary representation for each of the source device and the destination device based on the gamut shape information previously accessed, as shown at block 406.

At block 408, the color management system determines a gamut mapping model for mapping color data from the source device gamut to the destination device gamut based on gamut information for the devices. In various embodiments of the invention, the gamut mapping model is determined based on one or both of the gamut shape information accessed at block 404 and the gamut boundary representations determined at block 406.

To allow a user to modify parameters and control aspects of the gamut mapping, the color management system may present a user interface, as shown at block 410. The user interface may allow the user to adjust a variety of parameters of the gamut mapping model. The color management system receives any parameter modifications made via the user interface at block 412. It should be noted that the parameters of gamut mapping models may be modified by a user at any time and saved within a database. Accordingly, the gamut mapping model determined at block 408 may already have user modified parameters.

At block 414, the color management system then invokes the gamut mapping model. The color management system applies the gamut mapping model and any parameter modifications to the color data, thereby mapping the color data from the source device to the destination device.

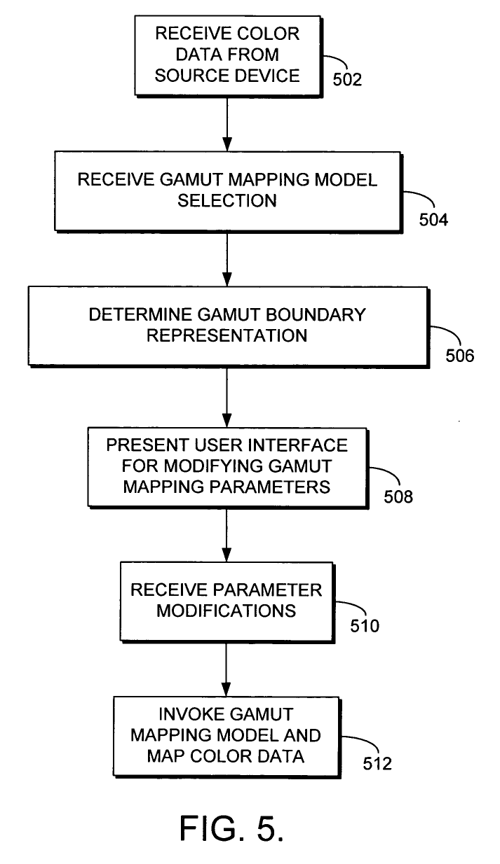

Referring to FIG. 5, a flow diagram is provided illustrating another exemplary method 500 in which a color management system (e.g., the color management system 300 of FIG. 3) maps color data from a source device gamut to a destination device gamut in accordance with an embodiment of the present invention. Initially, the color management system receives color data from the source device at block 502.

At block 504, the color management system receives a selection of a gamut mapping model. The gamut mapping model selection may be a manual or automatic selection based, for example, on user input, API usage, or other constraints (e.g., a particular rendering intent). Based on the selected gamut mapping model, the color management system determines the appropriate gamut boundary representation to employ, as shown at block 506. Some gamut mapping models may support multiple types of boundary representations. Accordingly, the color management system may determine the boundary representation that is best suited. The color management system may access information regarding the device gamut shape in order to determine the appropriate boundary representation (e.g., the one that most nearly matches the device's gamut shape). The process may further involve sets of optimized routines to convert from the ideal gamut structure to the actual one being used.

To allow a user to modify parameters and control aspects of the gamut mapping, the color management system may present a user interface, as shown at block 508. The user interface may allow the user to adjust a variety of parameters of the gamut mapping model. The color management system receives any parameter modifications made via the user interface at block 510. As discussed with respect to method 400, it should be noted that the parameters of gamut mapping models may be modified by a user at any time and saved within a database. Accordingly, the gamut mapping model selected at block 504 may already have user modified parameters.

At block 512, the color management system then invokes the gamut mapping model. The color management system applies the gamut mapping model and any parameter modifications to the color data, thereby mapping the color data from the source device to the destination device.

As can be understood, embodiments of the present invention provide a color management system that provides gamut mapping between a source device and destination device using the gamut shapes for the devices. Further embodiments of the present invention provide a method for mapping color data from a source device gamut to a destination device using the gamut shapes for each of the source device and destination device.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A color management system for mapping color data from a source device gamut associated with a source device to a destination device gamut associated with a destination device using information regarding a gamut shape for the source device and information regarding a gamut shape for the destination device, the color management system comprising:
a gamut shape determining component for accessing the information regarding the gamut shape for the source device and the information regarding the gamut shape for the destination device;
a gamut mapping model association component for associating at least one gamut mapping model with the information regarding the gamut shape for the source device and the information regarding the gamut shape for the destination device; and
a gamut mapping model invoking component for invoking the at least one gamut mapping model and applying at least one gamut mapping algorithm of the at least one gamut mapping model to map the color data from the source device gamut to the destination device gamut in a color appearance space.

2. The color management system of claim 1, further comprising:
a gamut boundary representation determining component for determining at least one of a source device gamut boundary representation and a destination device gamut boundary representation, the source device gamut boundary representation being determined based on the information regarding the gamut shape for the source device and the destination device gamut boundary representation being determined based on the information regarding the gamut shape for the destination device.

3. The color management system of claim 2, wherein the gamut mapping model association component associates at least one gamut mapping model with at least one of the source device gamut boundary representation and the destination device gamut boundary representation.

4. The color management system of claim 1, further comprising:
a gamut mapping parameter modification component for modifying at least one parameter of the at least one gamut mapping model.

5. The color management system of claim 4, wherein the gamut mapping parameter modification component presents a user interface for modifying at least one parameter of the at least one gamut mapping model.

6. The color management system of claim 5, wherein the gamut mapping parameter modification component receives at least one parameter modification of the at least one gamut mapping model via the user interface and modifies the at least one gamut mapping model.

7. The color management system of claim 1, further comprising:
a gamut mapping model database for storing at least one gamut mapping model.

8. The color management system of claim 1, further comprising:
a gamut mapping model plug-in component for receiving at least one plug-in gamut mapping model.

9. The color management system of claim 8, wherein the at least one plug-in gamut mapping model is stored in a gamut mapping model database.

10. A method for mapping color data from a source device gamut associated with a source device to a destination device gamut associated with a destination device based on information regarding a gamut shape for the source device and information regarding a gamut shape for the destination device, the method comprising:
accessing information regarding the gamut shape for the source device;
accessing information regarding the gamut shape for the destination device;
determining a gamut mapping model based on the information regarding the gamut shape of the source device and the information regarding the gamut shape of the destination device; and
invoking the gamut mapping model and applying at least one gamut mapping algorithm of the gamut mapping model to the color data to map the color data from the source device gamut to the destination device gamut in a color appearance space.

11. The method of claim 10, further comprising at least one of:
determining a source device gamut boundary representation based on the information regarding the gamut shape of the source device; and
determining a destination device gamut boundary representation based on the information regarding the gamut shape of the destination device;

12. The method of claim 11, wherein determining a gamut mapping model comprises:
determining a gamut mapping model based on at least one of the source device gamut boundary representation and the destination device gamut boundary representation.

13. The method of claim 10, further comprising:
presenting a user interface for modifying at least one parameter of the gamut mapping model.

14. The method of claim 13, further comprising:
receiving via the user interface a user modification of at least one parameter of the gamut mapping model; and
modifying the at least one parameter of the gamut mapping model.

15. The method of claim 10, wherein determining a gamut mapping model comprises:
accessing a database having a plurality of gamut mapping models; and
associating one of the plurality of gamut mapping models with the information regarding the gamut shape of the source device and the information regarding the gamut shape of the destination device.

16. One or more computer-readable media having computer-useable instructions embodied thereon for performing the method of claim 10.

17. A method for mapping color data from a source device gamut associated with a source device to a destination device gamut associated with a destination device, the method comprising:
receiving a selection of a gamut mapping model;
determining a source device gamut boundary representation based on the selected gamut mapping model;
determining a destination device gamut boundary representation based on the selected gamut mapping model; and
invoking the gamut mapping model based on the determined source device gamut boundary representation and the destination device gamut boundary representation, and applying at least one gamut mapping algorithm of the gamut mapping model to the color data to map the color data from the source device gamut to the destination device gamut in a color appearance space.

18. The method of claim 17, further comprising:
accessing information regarding a gamut shape for the source device;
accessing information regarding a gamut shape for the destination device;
wherein determining a source device gamut boundary representation is further based on the information regarding the gamut shape for the source device; and
wherein determining a destination device gamut boundary representation is further based on the information regarding the gamut shape for the destination device.

19. The method of claim 17, further comprising:
presenting a user interface for modifying at least one parameter of the gamut mapping model;
receiving via the user interface a user modification of at least one parameter of the gamut mapping model; and
modifying the at least one parameter of the gamut mapping model.

20. One or more computer-readable media having computer-useable instructions embodied thereon for performing the method of claim 17.
